(19) United States
(12) Patent Application Publication
(10) Pub. No.: US 2019/0327559 A1
(43) Pub. Date: Oct. 24, 2019

(54) MULTI-LISTENER BLUETOOTH (BT) AUDIO SYSTEM

(71) Applicant: Robert E. Smith, (US)

(72) Inventor: Robert E. Smith, Plano, TX (US)

(73) Assignee: Robert E. Smith, Plano, TX (US)

(21) Appl. No.: 15/957,073

(22) Filed: Apr. 19, 2018

(51) Int. Cl. H04R 3/12; H04W 8/00; H04W 8/22; H04R 3/04

(52) U.S. Cl. CPC H04R 3/12; H04W 8/005; H04R 2420/07; H04R 3/04; H04W 8/22

(57) ABSTRACT

Described herein is a device that includes: a storage with a data repository of BlueTooth (BT) listening device identification and corresponding features; and an audio processor coupled to the storage. The audio audio processor is further configured to execute instructions to: scan, connect, and receive an identification of a connected BT listening device; detect features of the connected BT listening device based from the received identification; manipulate an audio signal based from the detected features; and facilitate transmission of the manipulated audio signal to multiple connected BT listening devices.

### BACKGROUND

One of the goals of audio listening is a reproduction of original musical experience as closely as possible to original experience. This reproduction of the original experience includes recreating placement of a singer and musical instruments. Furthermore, speakers that broadcast sounds may be physically separated from each other to simulate audio channel separation in the audio recording. For example, the separation of the speakers generates a left and right audio channels from different speakers to reach predominantly the listener's left and right ears, respectively. This stereo separation recreate the original sound stage that listening to mono-channel audio cannot.

A traditional method of achieving the physical separation of stereo sound is through the physical separation of the speakers that are wired to an amplifier or device. One speaker that is physically disposed at the left side of the user may typically generate the left channel while the other speaker that is disposed at the right side of the user may typically produce the right audio signal. A disadvantage of this setup is the inconvenience brought by wired speakers and that the setup is typically not portable. In addition, the speaker wires can be unsightly and inconvenient.

### BRIEF DESCRIPTION OF THE DRAWINGS

FIG. 1 illustrates an example scenario as described in present implementations herein.

FIG. 2 illustrates an example block diagram of an apparatus suitable for implementing the technology described herein.

FIG. 3 illustrates a flowchart of an example process in accordance with technology described herein

### DETAILED DESCRIPTION

Described herein is a technology for implementing a Bluetooth (BT) multi-listener audio system by a device. The BT multi-listener audio system, for example, includes a plurality of BT listening devices that receive manipulated audio signals from the device. In this example, one or more activated BT speakers of the plurality of the BT speakers may broadcast the manipulated audio signals for listener's consumption. The manipulated audio signals include, for example, frequency filtered original BT signal, specific audio channels of the original audio signals, and the like.

In an implementation, the device may be configured to scan and pair or connect to each BT listening device of the plurality of BT listening devices. Furthermore, the device may receive a BT speaker identification of each connected BT listening device. Based on the received BT speaker identification, the device, for example, searches its data-repository to retrieve data associated to the received BT speaker identification. The data, for example, includes features of each connected BT speaker such as, but not limited to, operating frequency range, specific audio signal channel of operation, power amplification, available audio codecs, and the like.

Based on the retrieved associated data or features, the device may assign a particular audio signal channels (e.g., left or right channel) to a particular connected BT speaker. In another embodiment, the device may assign a particular frequency range to each connected BT speaker of the plurality of BT speakers. For example, the device assigns a low-frequency audio signal to a loud speaker. In another example, the device assigns a high-frequency audio signal to a high-pitch tweeter speaker. In these examples, the low-frequency and the high-frequency audio signals may be treated as separate audio channels. In these examples still, the assignments may be based on the retrieved associated data of the connected BT speakers.

After the assignment by the device of specific audio signal channels and frequency ranges, the device may generate a user-interface (UI) on a screen to display the different selections for BT speaker combinations that may be activated by the user. The user interface may appear on the device or an external audio player such as an iPhone or Android device. For example, the selections include activating the loud speaker alone, the high-pitch speaker alone, and/or a combination of the loud speaker and the high-pitch tweeter speaker to generate musical sounds. In response to a user input, the device directs the manipulated audio signal to the corresponding BT speaker to generate musical sounds.

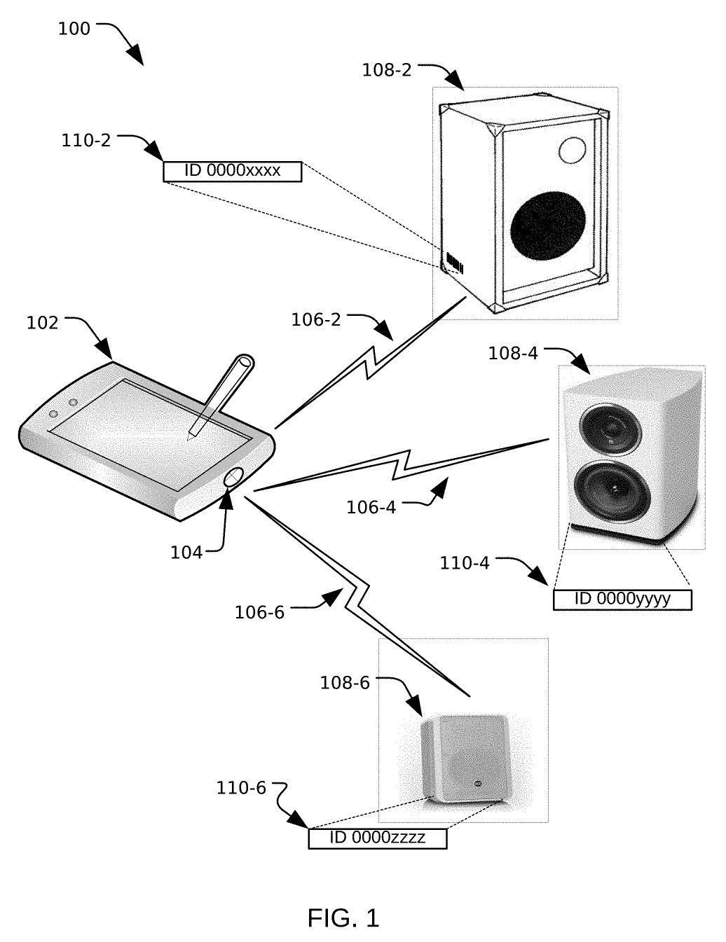

FIG. 1 is an example scenario 100 that utilizes manipulation of an audio signal, and subsequent transmission of the manipulated audio signal to a plurality of BT connected speakers as described herein. As shown, the scenario 100 includes a device 102 with an antenna 104, wireless signals 106, and a plurality of BT speaker 108 with corresponding speaker identification (ID) 110. The audio signal to be manipulated may be received from, for example, a BT transceiver (not shown) within the device. This audio signal may be manipulated prior to transmission and subsequent broadcasting by the plurality of BT speakers 108.

The device 102 may be an independent stand-alone device, or embedded to a tablet computer, a netbook, a notebook computer, a laptop computer, mobile phone, a cellular phone, a smartphone, a personal digital assistant, a multimedia playback device, a digital music player, a digital video player, a navigational device, a digital camera, and the like.

As described herein, the device 102 may include an integrated audio processor (not shown) that may be configured to execute instructions to manipulate the audio signal prior to its transmission to the plurality of BT speakers 108. For example, the audio processor may be disposed between the antenna 104 and the BT transceiver (not shown) of the device 102. In this example, the audio processor may receive and manipulate the audio signal from the BT transceiver. Thereafter, the audio processor may utilize the antenna 104 for transmission of the manipulated audio signal, which is a BT signal, to corresponding BT speakers 108.

In other cases, the audio signal may be received from sources external to the device 102. For example, the audio signal is supplied by a radio station. In this example, the BT transceiver within the device 102 may receive and store the audio signal first and thereafter, the BT transceiver supplies the stored audio signal for processing by the audio processor. Alternatively, the BT transceiver may receive the audio signal, and supply the received audio signal for processing by the audio processor in real time.

As described herein, the processed or manipulated audio signal includes frequency filtered audio signals that may correspond to operating frequencies of a particular BT speaker 108 (i.e., BT listening device). For example, a filtered frequency range of 20 Hz-200 Hz may be transmitted to a typical consumer sub-woofer speaker such as the BT speaker 108-2 that may include 20 Hz-200 Hz operating frequency range. In this example, the manipulated audio signal may further classified as a particular left or right channel that may be assigned to the BT speaker 108-2.

The manipulated audio signal may further adopt time-delayed arrival of the manipulated audio signal to a specified BT speaker 108. For example, the audio processor may be configured to synchronize a time delay in transmission of different frequency ranges and/or different audio channels that correspond to each BT speaker 108. The synchronized delay, for example, includes a delay of few microseconds in between each frequency range that are assigned to each BT speaker 108. In this example, each of the BT speaker 108 may play the received manipulated audio signal based upon the configured delay in the audio processor.

As described herein, the audio processor may pair with each BT speaker 108 using the wireless signals 106. For example, the pairing includes associating the BT speakers 108 to the device 102. In this example, the pairing may include receiving speaker ID 110 of the associated BT speaker 108. The audio processor may then utilize the BT speaker ID 110, for example, to retrieve from a data structure the data associated to the BT speaker ID 110.

For example, the data structure is a look-up-table (LUT) that includes different BT speaker IDs 110 and corresponding speaker features. The speaker features, in this example, may include operating frequencies or frequency ranges of the speaker, amplification characteristics, specific audio channels, and the like. In this example still, the audio processor may retrieve and use the corresponding BT speaker features in assigning each generated signal to the particular associated BT speaker 108.

For example, the speaker IDs 110-2 to 110-6 may include the corresponding operating frequency ranges of low, mid, and high frequencies, respectively. In this example, the manipulated audio signals that include these corresponding operating frequency ranges may be assigned to the speakers 108-2, 108-4, and 108-6, respectively. Furthermore, the low frequency signals are assigned as a particular first audio channel and broadcasted through the BT speaker 108-2, the mid-frequency signals are assigned as another particular second audio channel and broadcasted through the BT speaker 108-4, and so on.

Furthermore, the device 102 may delay transmission of each audio signal with a particular operating frequency range. For example, the speakers 108-2, 108-4, and 108-6 may receive the low, mid, and high frequencies, respectively, with some amount of time delay in between. In this example, the speakers 108-2, 108-4, and 108-6 may generate sounds based on these different time delays.

In other instances, the audio processor may be disposed outside of the device 102. For example, the audio processor is a standalone device that operates independently from the device 102 and the plurality of BT speakers 108. In this example, the audio processor may receive and manipulate the BT signal from the device 102. Thereafter, the audio processor may be configured to re-transmit the generated signals to the corresponding BT speaker 108. That is, each BT speaker 108 may receive the signals that were assigned to it based on its retrieved speaker features.

Referencing FIG. 1, the device 102 is playing music from Pandora or Spotify where the audio signals are transmitted to the BT speakers 108 through the BT signal 106. In this depiction, the device 102 may first pair or connect with the BT speaker 108, and then detect the features of each BT speaker 108 based on their corresponding speaker ID 110. Thereafter, the manipulation of the audio signals, and the subsequent assignment of each manipulated audio signal, may be based upon the detected features of each speaker 108.

As described herein, the BT signal 106 includes an operating frequency between 2.402 GHz and 2.480 GHz. This operating frequency may be used using a technique called “spread-spread frequency hopping.” For example, after the manipulation and assignment of the audio signal to a particular BT speaker 108, the assigned particular audio channel or operating frequency may be carried by the BT signal 106 to corresponding designated BT speaker 108. In this example, the BT speakers 108-2 to 108-6 may receive and play different signals based on each speaker's detected features. For example, the BT speaker 108-2 may play a left channel and/or low frequency signals, the BT speaker 108-4 may play a right channel and/or mid frequency signals, the BT speaker 108-6 may play a combination of right and left channels, and the like.

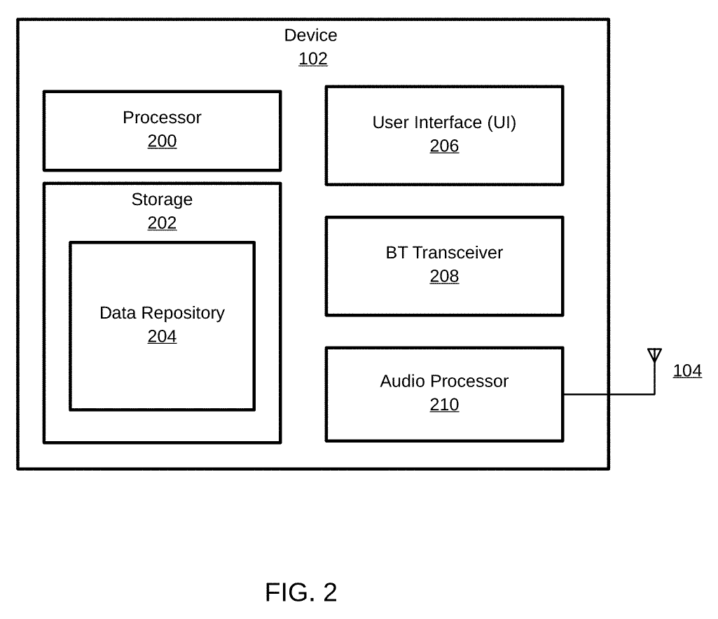

FIG. 2 illustrates an example block diagram of an apparatus suitable for implementing the technology described herein. Particularly, the apparatus may include the device 102. As depicted, the device 102 includes at least one processor 200, a storage 202 with a data repository 204, a user interface (UI) 206, a BT transceiver 208, an audio processor 210, and the antenna 104.

The processor 200 may include one or more processors that may be coupled to the storage 202. The processor 200, in an embodiment, may implement function of the audio processor 210 and other functionalities of the device 102.

The storage 202 may include a non-volatile storage such as, but not limited to, a magnetic disk drive, optical disk drive, tape drive, an internal storage device, an attached storage device, flash memory, battery backed-up SDRAM (synchronous DRAM), and/or a network accessible storage device. The storage 202, for example, may store videos, music, music channel websites, etc. that may be transmitted and played through the plurality of speakers 108. In another example, the videos, music, music channel websites, etc. need not be stored when the device 102 directly transmits and plays these videos, music, etc. in real time or through on-line streaming via the plurality of speakers 108. The non-volatile memory will also store the application code for the audio processor, any additional required software, services and drivers. In addition, the storage should include volatile memory such as RAM.

The data repository 204 may include a location designated for the storage of instructions and/or configuration parameters required by the device 102 and its sub-components including the audio processor 210, the user interface 206 and the BT transceiver 208. The data repository 204 may take the form of a database, a flat file system or any other technology available for the storage and retrieval of data. The data repository 204 may include the LUT for searching of the BT speaker IDs 110, and the data associated to each speaker 108.

For example, for the BT speaker 108-2, the data repository 204 may include a particular speaker ID 110-2 of the BT speaker 108-2, and the corresponding features associated to the BT speaker 108-2. In this example, the corresponding features stored in the data repository 204 may be used in the assignment of the default settings for the manipulated signals, default settings in general, and specific manipulation settings for predefined speakers as described herein. In addition, the data repository 204 may include the default parameters for the application or firmware for the audio processor 210, previously connected BT devices, BT connected device description as to whether it is a source or sink, security settings for pairing and connecting to BT devices, the device information for this device itself, the device information for this device that is broadcasted to other BT sink and source devices, the audio codecs available for use, the priority preference of the audio codec usage, the software and drivers installed on this device, the version of software and drivers installed, the application features available for the user, the user interface type and additional information that is necessary for the startup and execution of this device.

The UI 206 may facilitate interaction between a user and the device 102. For example, the UI 206 may display the speaker selections based on audio signal assignments to each speaker 108. In this example, the user may choose or select the speaker or speakers that the user may want to activate in order to play the audio signals to be transmitted. In this example still, the speaker selections may include different configured combinations of the speakers 108 to be activated. The UI 206 may exist within the device 102 or within a separate device, such as an application running on an iPhone or Android device.

For example, based on the detected features of each speaker 108, the configured combinations may include transmitting low frequency audio signals to the BT speaker 108-2, and high frequency audio signals to the BT speaker 108-6. In another example, location of the BT speaker 108-4 relative to the device 102 may generate different noises due to distance or interferences. In this other example, the speaker selections may indicate that the BT speaker 108-4 is not included in the configured combinations due to presence of noise.

The BT transceiver 208 may include at least one BT transceiver that facilitates wireless communications for the device 102 at an operating frequency between 2.402 GHz and 2.480 GHz. For example, the BT transceiver 208 may transmit the BT audio signal to the plurality of associated speakers 108. In this example, the transmitted audio signal may be carried by an Adaptive Frequency-Hopping (ADF) enabled signals 106. In another example, the BT transceiver 208 may utilize other operating frequencies that are suitable for transmitting the audio signals as described herein.

The audio processor 210 may be coupled to the processor 200 and the storage 202. Furthermore, the audio processor 210 may be disposed in between the BT transceiver 208 and the antenna 104. In other embodiment, the audio processor 210 and the processor 200 is one and the same component.

The audio processor 210, in cooperation with the processor 200 and the storage 202, may process the speaker ID data received through the antenna 104. Based on the received speaker ID data, the audio processor 210 may manipulate the audio signal from the BT transceiver 108. For example, the audio processor 210 may execute instructions to search and retrieve the associated data based on the received speaker ID data. Thereafter, the audio processor 210 may execute instructions to manipulate the audio signal.

As described herein, the audio processor 210 provides for the receiving, duplication, manipulation and transmission of the audio signal from the device 102 to a multitude of BT listening devices. The audio processor 210 loads the default parameters (e., instructions to execute) from the data repository 204 upon initial power up of the device.

As described herein, the audio processor 210 uses the loaded configuration settings from the data repository 204 to set the parameters of the audio processor's behavior including the name of the device itself, what type of user interface is available, the method for communicating with the user interface, available features for the device and additional information needed for startup and operation of the device.

In an embodiment, the audio processor 210 may be configured to detect if an audio player device is connected to at least one BT audio listening device such as the BT speaker 108. Based on this detection, the audio processor 210 will determine the needed manipulation of the audio signal and manipulate it as specified by the pre-configured manipulation—parameters loaded to the audio processor 210.

The manipulation parameters may include frequency filtering of the audio signal, separation of different audio signal channels into independent left channel/right channel, indication of maximum amount of power amplification, conversion of incoming audio codec to a codec available to the BT speaker 108 and presence of time delay for each transmission of the manipulated audio signal to the BT speaker 108. For example, device 102 receives an incoming AAC audio codec from the audio player 100 and converts it to the SBC audio code for the BT speaker 108. An additional scenario is where device 102 determines that the audio player 100 is capable of sending either the AAC or SBC audio codec and that the BT speaker 108 is only capable of utilizing the SBC audio codec. In this scenario, the device 102 request the SBC audio codec from the audio player 100 and processes and transmits the SBC audio codec to the BT speaker 108.

The antenna 104 may facilitate transmitting and receiving of data by the device 102. For example, the device 102 may receive the speaker ID 110 of the BT speaker 108 through the antenna 104. In this example, the audio processor 210 searches the data repository 204 in order to retrieve the data associated with the received speaker ID 110. Based on this retrieved associated data, the manipulated signal is assigned to each associated speaker 108. Thereafter, the BT transceiver 208 facilitates the transmission of the assigned manipulated signal to the designated speaker 108.

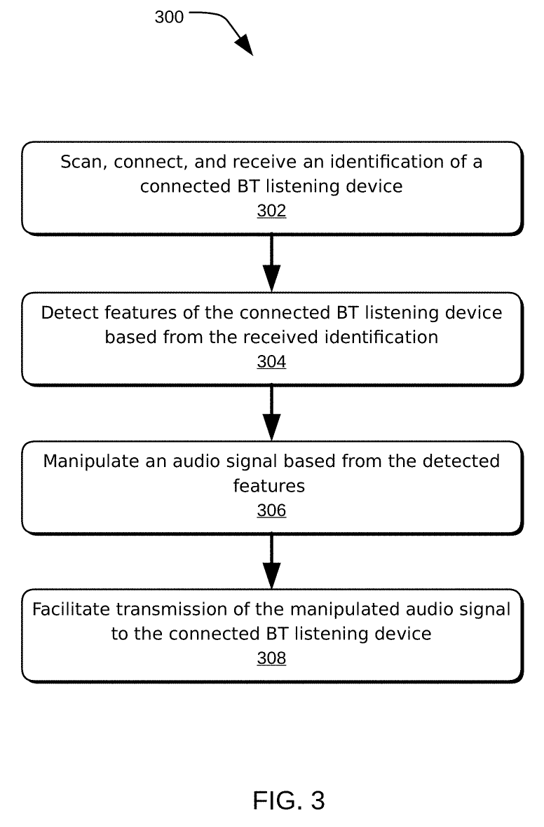

FIG. 3 shows a flowchart 300 of an example process in accordance with technology described herein. The order in which the method is described is not intended to be construed as a limitation, and any number of the described method blocks may be combined in any order to implement the method, or alternate method. Additionally, individual blocks may be deleted from the method without departing from the spirit and scope of the subject matter described herein. Furthermore, the method may be implemented in any suitable hardware, software, firmware, or a combination thereof, without departing from the scope of the invention.

At block 302, scan, connect, and receive identification by a device of a connected BT listening device. For example, the device 102 and particularly, the audio processor 210 may scan and connect with a BT speaker 108-2. In this example, the audio processor 210 receives the speaker ID 110-2 of the BT speaker 108-2. Thereafter, the audio processor 210 searches a look-up-table (LUT) of the data repository 204 to retrieve data associated to the received speaker ID 110-2 of the BT speaker 108-2.

For example, the associated data includes operating frequency range of the BT speaker 108-2. In another example, the associated data includes specific audio channels to be assigned to the BT speaker 108-2. In another example still, the associated data includes amount of signal amplification by the BT speaker 108-2. The amount of signal amplification, for example, may include an amount of power amplification where the manipulated signal will not be distorted.

At block 304, the example device detect features of the connected BT listening device based from the received identification. For example, the audio processor 210 utilizes the LUT that includes the BT listening device identification and the corresponding features. In this example, the received speaker ID 110-2 of the BT speaker 108-2 may correspond to different features such as operating frequency range, specific audio channels, and amount of signal amplifications.

At block 306, the example device manipulates an audio signal based from the detected features. For example, the audio signal may be generated by the device 102 or it is generated from an external source. In this example, the audio processor 210 may execute instructions to assign specific audio channels to the BT listening device, assign specific frequency range, convert the audio signal to an audio codec that the BT Speaker 108 can process and indicate amount of signal amplification. In this example still, the manipulation of the audio signal by the audio processor 210 may be based from the detected features of the connected BT speaker 108-2.

In an embodiment, the device 102 may further include the UI 206 that displays selection of BT speaker combinations to be activated. For example, the UI 206 displays the activation of each BT speaker 108. In this example, the user may select which BT speaker or combination of BT speakers to activate.

At block 308, the example device facilitates transmission of the manipulated audio signal to the connected BT listening device For example, the audio processor 210 may facilitate the transmission of the manipulated signal to the connected BT speaker 108-2. In this example, the transmission includes delaying transmission of the manipulated audio signal to the connected BT listening device by a specified amount of time.

For example, the transmission of the manipulated audio signals to each of the BT speaker 108 is delayed by few microseconds. In this example, each of the BT speaker 108 may similarly generate sounds based on the corresponding delayed audio signal transmission. In this example still, each BT speaker 108 may generate the sounds independent of the other audio signal that is transmitted to another BT speaker 108.

1. A device comprising:
a storage for instructions and configuration parameters required by the device;
an audio processor coupled to the storage, the audio processor to execute instructions to:
scan, connect, and receive an identification of a first connected BT listening device and a second connected BT listening device;
detect features of the first and second connected BT listening devices based from the received identification;
manipulate an audio signal based from the detected features; and
facilitate transmission of the manipulated audio signal to one of the first and second connected BT listening devices based on user determination of which of the first and second connected BT listening devices that the user desires the audio signal to be transmitted to; and
a set of BT transceivers for transmitting audio to external BT listening devices.

2. The device as recited in claim 1 further comprising a BT transceiver that supplies the audio signal to the audio processor.

3. (canceled)

4. The device as recited in claim 1, wherein the manipulation of the audio signal includes assignment of one or more specific audio channels to the first and second connected BT listening device.

5. The device as recited in claim 1, wherein the manipulation of the audio signal includes filtering the audio signal to a specific frequency range.

6. The device as recited in claim 1, wherein the facilitating transmission includes delaying transmission of the manipulated audio signal to the first and second connected BT listening device by a specified amount of time.

7. The device as recited in claim 1 further comprising a selection of BT speaker combinations to be activated by the audio processor.

8. The device as recited in claim 1, wherein the manipulation of the audio signal includes conversion of the audio codec to a format understandable by the BT speaker.

9. A method of generating an audio signal in a BlueTooth (BT) multi-device listening audio system, the method comprising:
scanning, connecting, and receiving an identification by a device of a first connected BT listening device and a second connected BT listening device;
detecting features of the first and second connected BT listening devices;
manipulating the audio signal based from the detected features;
facilitating transmission of the manipulated audio signal to one of the first and second connected BT listening devices based on user determination of which of the first and second connected BT listening devices that the user desires the audio signal to be transmitted to.

10. (canceled)

11. The method as recited in claim 9, wherein the manipulation of the audio signal includes assignment of specific audio channels to the connected BT listening device.

12. The method as recited in claim 9, wherein the manipulating of the audio signal includes filtering the audio signal to a specific frequency range.

13. The method as recited in claim 9, wherein the facilitating transmission includes delaying transmission of the manipulated audio signal to the connected BT listening device by a specified amount of time

14. The method as recited in claim 9 further comprising:
displaying an image that includes a selection of BT speaker combinations to be activated by an audio processor.

15. A method comprising:
scanning, connecting, and receiving identification by a device of a first connected BT listening device and a second connected BT listening device;
detecting features of the connected BT listening device based from the received identification;
receiving and manipulating the audio signal based from the detected features;
facilitating transmission of the manipulated audio signal to one of the first and second connected BT listening devices based on user determination of which of the first and second connected BT listening devices that the user desires the audio signal to be transmitted to.

16. (canceled)

17. The method as recited in claim 15, wherein the manipulation of the audio signal includes assignment of specific audio channels to the connected BT listening device.

18. The method as recited in claim 15, wherein the manipulating of the audio signal include filtering the audio signal to a specific frequency range.

19. The method as recited in claim 15, wherein the audio signal is received within or external to the device.

20. The method as recited in claim 19, wherein the facilitating transmission includes delaying transmission of the manipulated audio signal to the connected BT listening device by a specified amount of time
